(19) United States
(12) Patent Application Publication
(10) Pub. No.: US 2003/0208726 A1
(43) Pub. Date: Nov. 6, 2003

(54) Incremental cost calculation for fast wire length minimization

(75) Inventor: Andy Huang, San Jose, CA (US)

Correspondence Address: ANDY HUANG, 2880 ZANKER ROAD, SUITE 203, SAN JOSE, CA, 95134, US

(73) Assignee: ACAD Corp., San Jose, CA (US)

(21) Appl. No.: 10/063,624

(22) Filed: May 3, 2002

(51) Int. Cl. G06F 17/50

(52) U.S. Cl. 716/2; 716/1; 716/11; 716/8

(57) ABSTRACT

Compacting layout is the process of shrinking the polygons that were devices and wires, and were represented thorough the GDS (general data stream) standard format. To shrink the polygons under the constraints and rules for VLSI design and manufacturing, there is lots of computation time to find optimum width. Especially, the wire is the most complex and takes the most of the time among devices, such as transistors, resistors, and capacitors in the VLSI design. Proposed is the technique to reduce the most computation time in computation of wire length in the shrinking the VLSI layout design. By applying the incremental technique on the shrinking the wire minimization procedure, the performance of the compaction can be improved compared with the technique without incremental one. Wire length minimization process can be formulated by the linear programming, and find optimum solutions by the Simplex[1]. The Simplex is the technique to find global solutions, by applying successive conversion with “pivoting”[1]. The successive conversion procedure is based on the graph theory; set the initial spanning tree, convert it with less cost if any, repeatedly, until there is tree that has minimum cost. The performance can be achieved since the computation to find the cost is performed only on the transformed tree node of the spanning tree

### CROSS REFERENCE TO RELATED APPLICATIONS

C. H. Papadimitriou and K. Steiglitz, Combinatorial Optimization: Algorithms and Complexity, Englewood Cliffs, N.J. 07632, USA: Prentice-Hall, Inc., 1982. [2]J. F. Lee and C. K. Wong, “A Performance-Aimed Cell Compactor with Automatic Jogs,” IEEE Transaction On Computer Aided Design, vol. 11, no. 12, December, 1992.

### BACKGROUND OF INVENTION

It is popular that hundreds of millions of transistors integrated in a chip, and lots of complex functions is fabricated in a chip to meet the needs for the current systems. Also, IP in the VLSI community make the re-use of proved design at the old manufacturing technology and remove burden to verify and simulate the design again. The layout migration or technology retargeting becomes one of the inevitable techniques to meet the needs for the re-use technology, it automatically convert and shrink the polygon of the layout to reduce the size while meets the design rule that the layout is manufactured. In the layout level in the VLSI design flow, all the devices, for example transistor, resistor, and capacitor, etc, are represented by the corresponding polygons. And the polygons to form the device may or may not at the same layer, and usually the design is implemented with the several layers. Each of the polygons and layer are the basic component to manufacturing at the VLSI fabrication. Compaction in the layout migration is the process to shrink and to build the minimum width and length layout data while follows the design rule. Since the layout data were represented by the polygon, the compaction process tackles with more than the ten times with that of the size of the transistors in the design. As the circuit becomes complex, the numbers of the polygon in the layout increases exponentially. These are the reason why the performance is the first concern in the migration process. The wire is the most complex in the compaction, and it affects the performance of the migration time and memory usage. As described briefly, the wire length minimization is described by the linear programming technique, and find the optimum solution by the Simplex[1] method. Although there have been lots of researches, still there are not suitable method yet to meet complex current VLSI design. Proposed is the technique to meet the current complex migration, by applying the incremental technique to find minimum wire length.

### DETAILED DESCRIPTION

Minimizing the wire length during the compaction process can be represented by linear programming method, and is solved by the Simplex[1]. The Simplex is finding the global solution by repeatedly applying the solution process, called “Pivoting”. As shown in the following algorithm, build the spanning tree is the first step to find the solution. The spanning tree is built by the longest path search algorithm, and the initial solution is from the spanning tree, and search process is applied to see if there is any other minimum solution on the tree. And the spanning is modified if there is a minimum solution, it continues until there is no change in the spanning tree.

Procedure Simplex[2]

Mark all the arcs of the spanning tree as not visited; While (there is any arc marked as not visited) {Take a not visited arc eᵢₙ=(Vᵢ, Vⱼ); Partition the spanning tree into two subtrees {T₁,T₂IV₀∈T₁}; Let dir be the move direction of T₂; Let eₒᵤₜ=eᵢₙ; If (dir×C(T₂)<0) {Let δ× be the maximal allowable move; If (δ×≠0) {Move nodes in T₂ by δ×; Set the new tight arc=eₒᵤₜ;}else Choose an tight arc between T₁ and T₂=eₒᵤₜ;} if (eₒᵤₜ≠eᵢₙ) {Replace eᵢₙ with eₒᵤₜ; Mark eₒᵤₜ as visited and the rest of the tree arcs as not visited;}else Mark eᵢₙ as visited;}

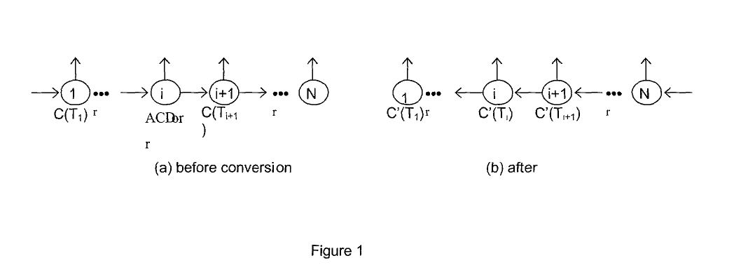

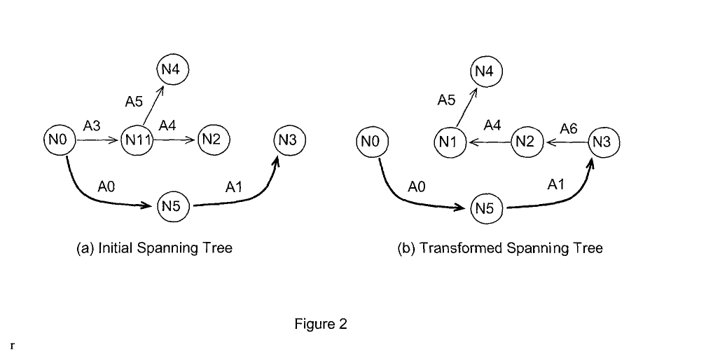

The cost is C(T₂) at the example, it should be computed at every iteration as shown in FIG. 1.

If the spanning tree is changed from the (a) to (b), the cost at each of the nodes also changed from C to C, and the computation is as follows, C(T₁)=C(T₁) C(T₂)C T₂)=C(T₂)+C(T₁) C(T₃)=C(T₁)C(T₃)C(Tᵢ)=C(Tᵢ)+C(Tᵢ₋₁)C(Tᵢ₊₁)=C(T₁) C(Tᵢ₊₁)Therefore, the new cost C is C(T₁) C(Tᵢ₊₁) at the tree node Tᵢ. as Shown in FIG. @

Assumption is made that node N0, N5, and N3 are critical path as shown at the figure. The critical path means the longest path in the graph. If we remove the arc A3 and add arc A6 in order to get new spanning tree with less cost, there is no change at the cost of N4, because there is no change in the sub-tree. It is not necessary to calculate the cost of N0, N5, and N3, because these are the critical nodes. Just update the cost of N1 and N2 is all required to find cost calculation.

1. Applying Simplex[1] method at the graph, cost computation is done only on the transformed tree node Initial spanning tree is formed with the longest path search algorithm, and each of the nodes in the tree is calculated to find the cost. The cost of the node is defined as the sum of the weight on the path from the node between the nodes in the tree. The spanning tree is reformed if there is minimum cost. The spanning tree reformed until there is no change in cost, and the cost calculation procedure is done only on the transformed tree node in order to cut the computation time.
